(19) United States
(12) Patent Application Publication
(10) Pub. No.: US 2001/0040974 A1
(43) Pub. Date: Nov. 15, 2001

(54) Horn mode tuning

(76) Inventor: Jerome D. Steckling, Petaluma, CA (US)

Correspondence Address: IRELL & MANELLA LLP, Suite 900, 1800 Avenue of the Stars, Los Angeles, CA, 90067, US

(21) Appl. No.: 09/764,768

(22) Filed: Jan. 16, 2001

Related U.S. Application Data
(60) Provisional application No. 60/176,407, filed on Jan. 13, 2000.

(51) Int. Cl. H04R 1/20

(52) U.S. Cl. 381/345; 381/351; 181/145

(57) ABSTRACT

A sound reproduction device according to the present invention may include a tuning device to minimize reflected sound distortion. The tuning device may include one or more sets of pre-tuned or adjustable chambers arranged perpendicular to the direction of sound propagation. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BACKGROUND OF THE INVENTION

1. Field of the Invention

This invention relates to sound reproduction, and more specifically to minimizing distortion in sound reproduction devices.

2. Description of the Prior Art

Sound reproduction devices may have non-uniform expansion rates along the path of sound travel causing sound reflections that may cause the sound to reverse direction along the path of sound travel and cause standing waves (high and low pressure locations).

Non-uniform expansion rates may be used in some sound reproduction devices to effect their directivity, usually by causing restrictions in the path of sound travel where the diffraction of sound causes a desired pattern of directivity of the band-pass energy.

The reflected energy may then reflect again off of the compression driver diaphragm and then along the path of sound travel. The reflected energy is now introduced in with the initial sound, the resulting total sound is now smeared in time. This distortion is reflected in measurements of magnitude, phase, and very apparent audibly as a sound coloration.

### SUMMARY OF THE INVENTION

Resonances that occur may distort the magnitude and phase responses because of the reflected energy's later time arrival and lower damping rate than the initial sound and the remaining reflected energy in the bandpass. These resonances are the area of concentration of the invention. However, the tuning method used may also dampen the entire bandpass in varying degrees.

The features and advantages of this invention will become apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a side view of a sound reproduction device and tuning device according to the present invention.

FIG. 2 is a front cutaway view of the tuning device of FIG. 1.

FIG. 3 is an isometric view of the tuning device of FIG. 1.

FIG. 4 is a front view of an alternate embodiment of a tuning device according to the present invention.

FIG. 5 is a graph illustrating the second harmonic frequency response of a tuning device according to the present invention.

FIG. 6 is a graph illustrating the sensitivity reduction of a tuning device according to the present invention.

FIG. 7 is a graph illustrating the third harmonic frequency response of a tuning device according to the present invention.

### DETAILED DESCRIPTION OF THE PREFERRED EMBODIMENT(S)

Eigenmodes in a basic geometric shape will terminate in at least 2 points. In a labyrinth, it will be at both ends. In the acoustic horn device, the first point of termination is at the point source of the sound or compression driver 20 used to excite it. The other end of termination in the acoustic horn device is at any impedance transition or places along the horn where expansion rates change. The expansion rate change is what is used to effect directivity. This is usually referred to as a “diffraction slot”. At this point of the labyrinth, there are many parameters to consider and is somewhat anomalous as to the actual termination point because the air column behaves differently dependent upon frequency.

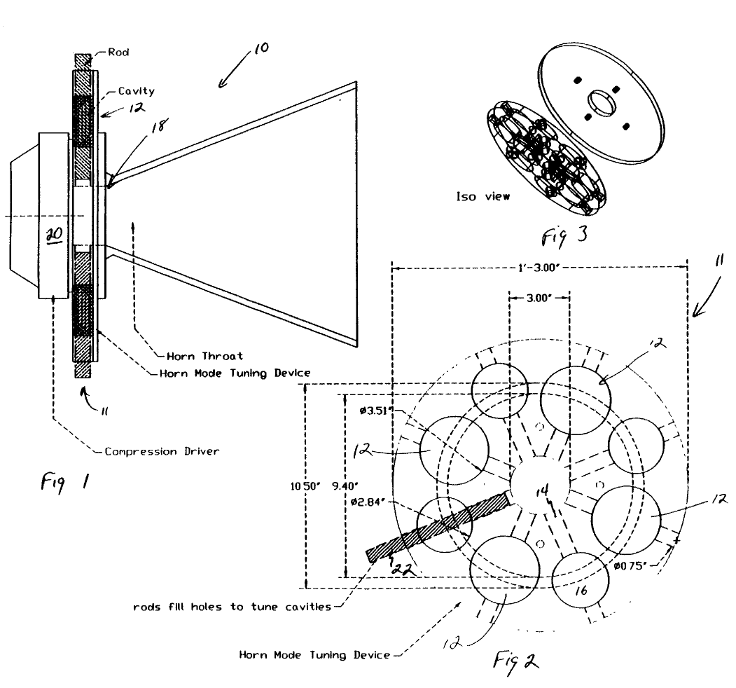

As shown in FIG. 1, a tuning device 11 effecting the tuning along the labyrinth's sides or near the diffraction slot itself may cause directivity changes in the intended coverage pattern and additional resonances may be detected in the higher portion of the bandpass.

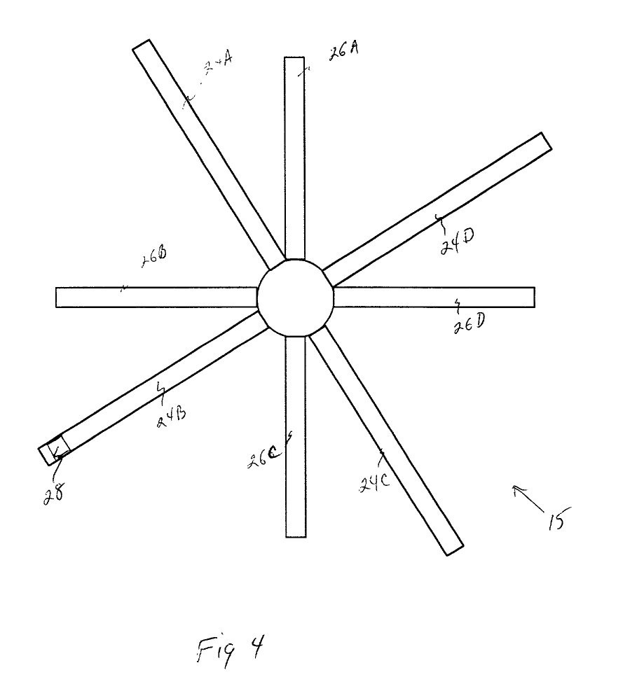

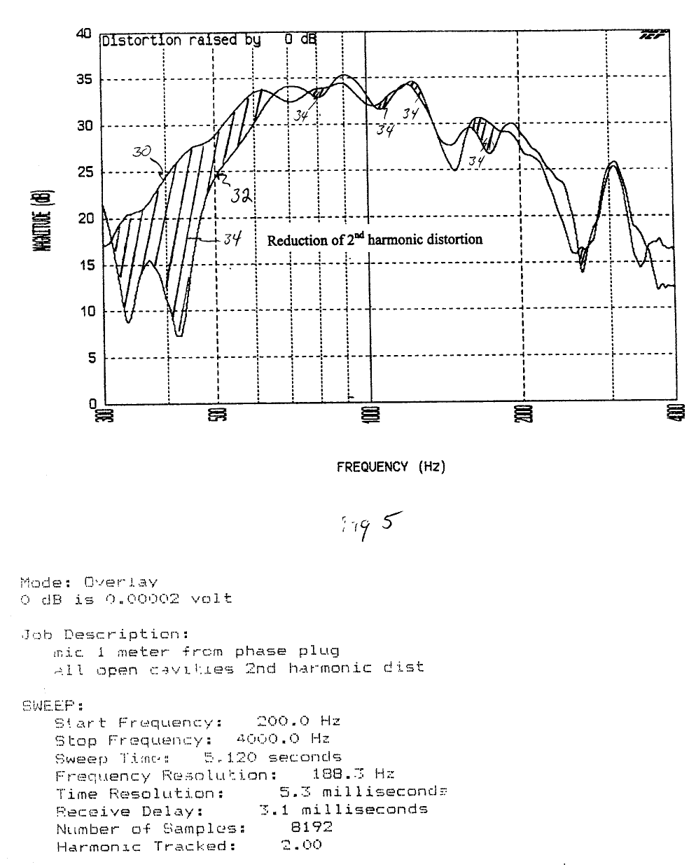

In a currently preferred embodiment of the present invention as shown in FIGS. 1 and 2, sound reproduction device 10 includes tuning device 11. Tuning device 11 may include one or more sets of tunable perfume bottle sized tuning chambers 12. Tuning chambers may be long and narrow and or short and wide and the tuning chambers may be cylindrical and or spherical and or may have many other suitable shapes. Throat 14 connects to chamber 16 and is imposed in neck 18 of sound reproduction device 10. Tuning chambers 12 may be tuned to resonate at the resonance frequencies of the horns natural resonances to minimize standing wave distortion.

Device 11 may be fabricated in a way that it can be employed as a neck adapter on most commercially available horns. Device 11 may be made of many suitable materials such as wood, acrylic, plastic, and metal. Each chamber 12 of device 11 may be tuned using moveable tuning rod 22.

Referring now to FIG. 4, tuning device 15 may include tuning element sets 24a-d and 26a-d. Each tuning element 24A may include a tuning rod 28. Tuning rod 28 may be adjustable or it may be fixed in place. Tuning rod 28 may be made of any suitable material such as wood, acrylic, plastic, or metal.

Testing of tuning device 11 has demonstrated that harmonic distortion may be reduced by several dB while only loosing a few dB in overall sensitivity.

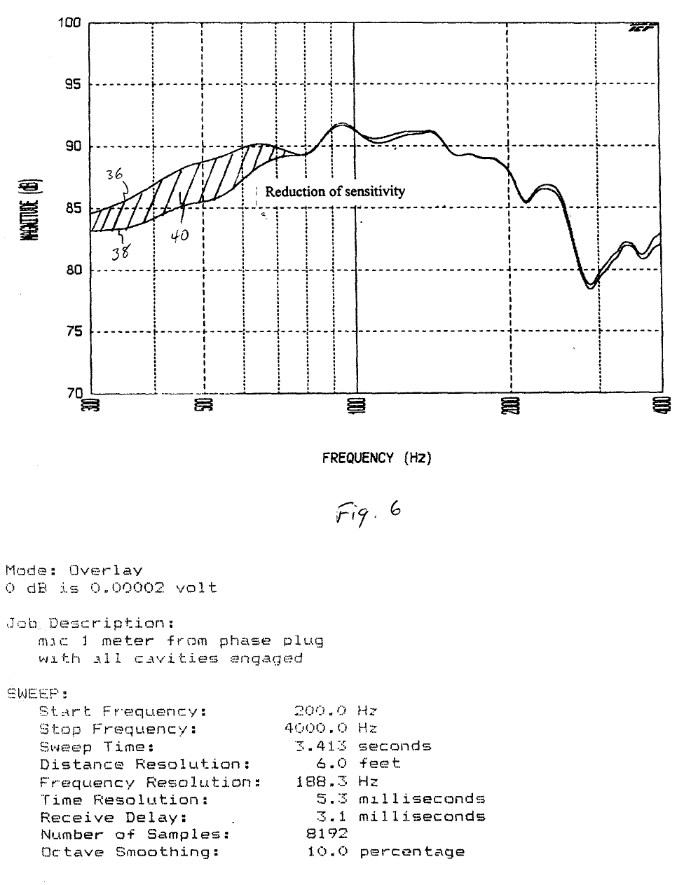

Referring now to FIG. 5, curve 30 is a tracing of the uncorrected second harmonic frequency response of a sound reproduction device such as sound reproduction device 10. Curve 32 is a tracing of the second harmonic frequency response of a sound reproduction device with a tuning device according to the present invention. Shaded areas 34 represents the improvement in second harmonic frequency response available due to tuning device 11.

Referring now to FIG. 6, curve 36 is a tracing of the uncorrected frequency sensitivity of a sound reproduction device such as sound reproduction device 10. Curve 38 is a tracing of the frequency sensitivity of a sound reproduction device with a tuning device according to the present invention. Shaded areas 40 represents the improvement in sensitivity available due to tuning device 11.

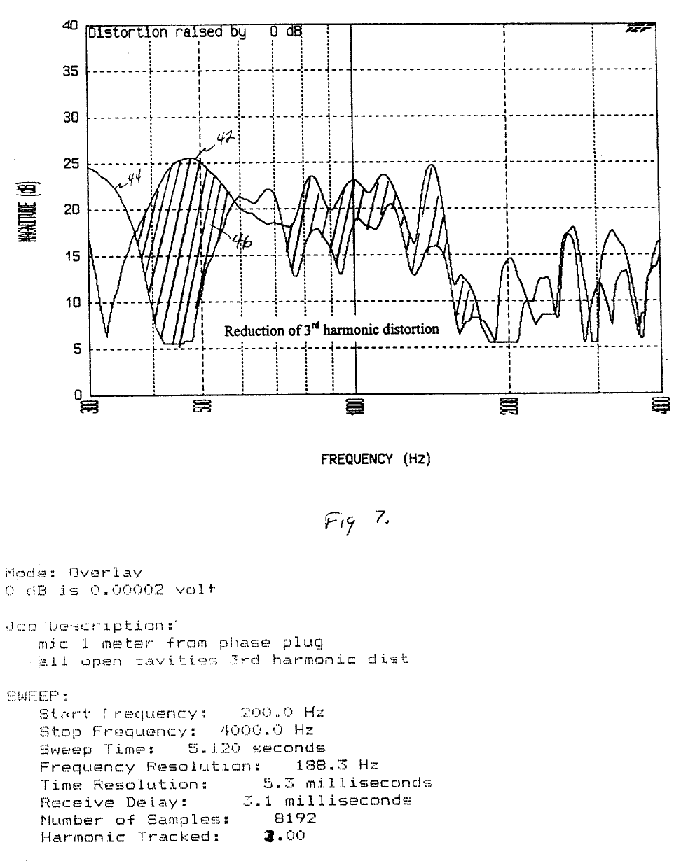

Referring now to FIG. 7, curve 42 is a tracing of the uncorrected third harmonic frequency response of a sound reproduction device such as sound reproduction device 10. Curve 44 is a tracing of the third harmonic frequency response of a sound reproduction device with a tuning device according to the present invention. Shaded areas 46 represents the improvement in third harmonic frequency response available due to tuning device 11.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

I claim:

1. A speaker tuning device comprising:
a cylindrical neck adapter forming a sound path;
one or more tuning orifices through the surface of the neck adapter perpendicular to the sound path;
a cavity, having a pre-selected tuning volume, connected to each of the one or more tuning orifices.

2. The device of claim 1 further comprising:
an adjustable tuning element fitted to one or more cavities for changing the tuning volume.

3. The device of claim 1 wherein the tuning orifices are symmetrically arranged about the sound path.

4. A speaker horn neck adapter comprising:
a duct forming a sound path; and
one or more cavities open to the sound path for tuning.

5. The device of claim 4 further comprising:
an adjustable tuning element fitted to one of the one or more cavities for changing the tuning volume.

6. The device of claim 4 further comprising:
an adjustable tuning element fitted to each of the one or more cavities for changing the tuning volume.

7. A sound reproduction device comprising:
means for converting an electrical input into sound energy;
means for directing the sound energy forming a sound path; and
means for tuning the directing means to minimize sound energy reflected along the sound path.

8. The device of claim 7 wherein the tuning means further comprises:
one or more sets of chambers symmetrically arranged around the sound path.

9. The device of claim 8 wherein the tuning chambers further comprises:
one or more sets of chambers symmetrically arranged around the sound path, each chamber having an adjustable volume.
